(19) United States
(12) Patent Application Publication
(10) Pub. No.: US 2024/0375192 A1
(43) Pub. Date: Nov. 14, 2024

(54) DRILLING TOOL

(71) Applicant: MILWAUKEE ELECTRIC TOOL CORPORATION, Brookfield, WI (US)

(72) Inventors: Travis J. DuMez, Port Washington, WI (US); Milorad Marich, Mequon, WI (US)

(21) Appl. No.: 18/690,167

(22) PCT Filed: Oct. 12, 2022
(86) PCT No.: PCT/US2022/046388

§ 371 Date: Mar. 7, 2024

Related U.S. Application Data
(60) Provisional application No. 63/255,131, filed on Oct. 13, 2021.

(51) Int. Cl. B23B 51/02

(52) U.S. Cl. CPC B23B 51/02; B23B 2251/046; B23B 2251/14; B23B 2251/408

(57) ABSTRACT

A drill bit includes a body having a first end, a second end, an axis of rotation defined through the first and second end, and a body flute that extends along the axis of rotation at a helix angle. The drilling tool also includes a cutting head attached to the second end of the body. The cutting head includes a first land, a second land, and a cutting head flute. The cutting head flute is defined between the first land and the second land. The cutting head flute extends along the axis of rotation at the helix angle such that the body flute and the cutting head flute form a continuous flute.

### CROSS-REFERENCE TO RELATED APPLICATIONS

This application claims priority to co-pending U.S. Provisional Patent Application No. 63/255,131, filed Oct. 13, 2021, the entire contents of which are incorporated by reference herein.

### FIELD OF THE INVENTION

The present invention relates to power tool accessories. More specifically, the present invention relates to masonry drill bits.

### BACKGROUND

Masonry drill bits are used to drill holes into hard materials such as concrete, stone, brick, tile and the like. Masonry drill bits require a harder cutting head compared to typical drill bits in order to drill through the harder materials. Masonry drill bits can be used with power tools such as rotary hammers that are operable in a drilling mode which only rotates the masonry drill, a chisel mode which delivers only percussive force to the masonry drill, or a hammer drill mode which rotationally drives the masonry drill and delivers a percussive force to the masonry drill.

### SUMMARY

In one aspect, the disclosure provides a drill bit including a body having a first end, a second end, an axis of rotation defined through the first end and second end, and a body flute that extends along the axis of rotation at a helix angle. The drilling tool also includes a cutting head attached to the second end of the body. The cutting head includes a first land, a second land, and a cutting head flute. The cutting head flute is defined between the first land and the second land. The cutting head flute extends along the axis of rotation at the helix angle such that the body flute and the cutting head flute form a continuous flute.

In another aspect, the disclosure provides a drill bit including a body and a cutting head. The body includes a first end, a second end, and an axis of rotation defined therethrough. The cutting head is attached to the second end. The cutting head includes a bottom end, a top end, and a land. The bottom end is attached to the second end of the body. The top end is opposite the bottom end. The land has a leading cutting edge and a trailing cutting edge. Each of the leading cutting edge and the trailing cutting edge extends between the top end and the bottom end of the cutting head and helically around the axis of rotation.

In another aspect, the disclosure provides a method of manufacturing a drill bit including forming a body having a first end, a second end, an axis of rotation defined through the first end and the second end, and a body flute that extends along the axis of rotation at a helix angle. The method also includes forming a cutting head including a first land, a second land, and a cutting head flute defined between the first land and the second land. The cutting head flute extends along the axis of rotation at the helix angle. The method further includes attaching the cutting head to the second end of the body such that the body flute and the cutting head flute form a continuous flute.

In some aspects, the cutting head may be manufactured using an additive manufacturing process.

Other aspects of the invention will become apparent by consideration of the detailed description and accompanying drawings.

### BRIEF DESCRIPTION OF THE DRAWINGS

FIG. 1 is a plan view of a drilling tool according to the prior art.

FIG. 2 is a plan view of a drilling tool according to an embodiment of the disclosure.

FIG. 3 is a perspective view of a cutting head for the drilling tool of FIG. 2.

FIG. 4 is a top view of the cutting head of FIG. 3.

FIG. 5 is a side view of the cutting head of FIG. 3.

FIG. 6 is another side view of the cutting head of FIG. 3.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

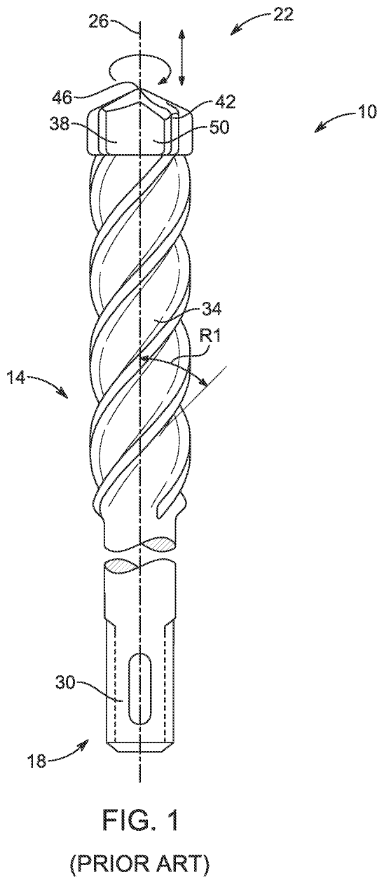

FIG. 1 illustrates a drilling tool 10 according to the prior art. The drilling tool 10 includes a body 14 having a first end 18, a second end 22 opposite the first end 18, and an axis of rotation 26 extending between the first and second ends 18, 22. A shank 30 is positioned adjacent the first end 18. The shank 30 is operable to connect the drilling tool 10 to a power tool such as a drill or rotary hammer. The drilling tool 10 also includes a body flute 34 that extends between the first and second ends 18, 22. In the illustrated embodiment, the drilling tool 10 includes four body flutes 34. Each body flute 34 extends between the first and second ends at a helix angle R1. The illustrated helix angle R1 is constant between the first and second ends. The drilling tool 10 further includes a cutting head 38 that is coupled to the second end 22 of the drilling tool 10. The cutting head 38 includes a plurality of webs 42 that extend from a tip 46. Head flutes 50 are disposed between the webs 42. Unlike the body flutes 34, the head flutes 50 of the cutting head 38 are not helically wrapped around the axis of rotation 26. Rather, the head flutes 50 extend axially parallel to the axis of rotation 26, causing a partial disconnect between the cutting head 38 and the body 14.

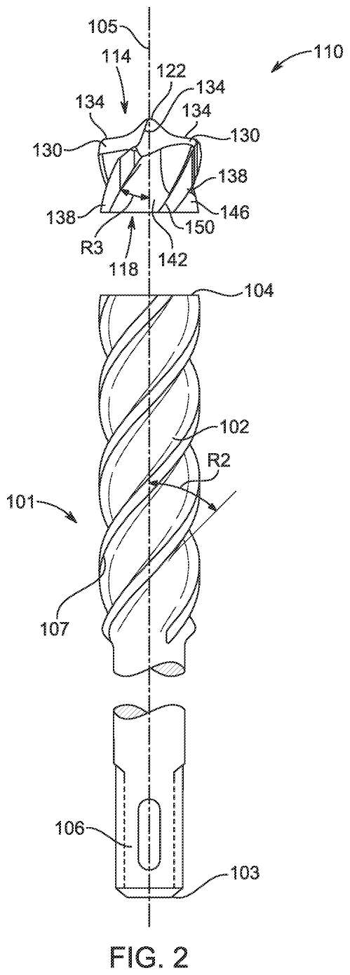

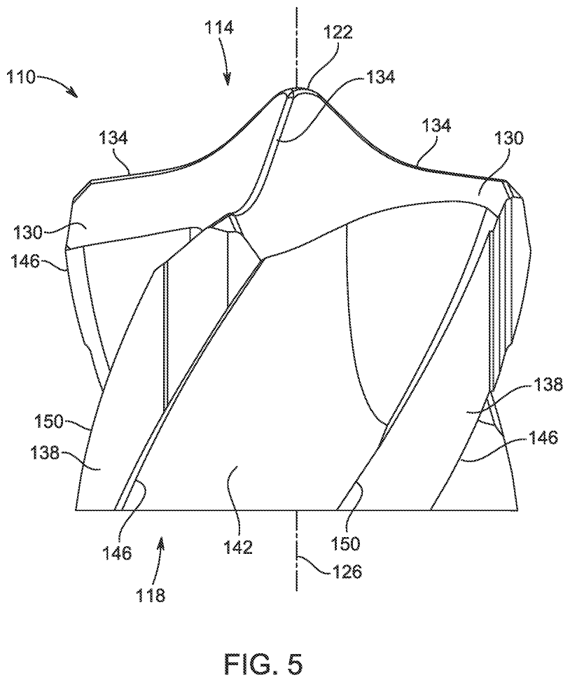

FIGS. 2-6 illustrate a drilling tool 101 including another cutting head 110. In the illustrated embodiment, the cutting head 110 is configured for use with a masonry drill bit. For example, the cutting head 110 may be used with the drilling tool 10 described above with reference to FIG. 1 in place of the cutting head 38. In other embodiments, the cutting head 110 may be configured for use with other drilling tools such as augers, drill bits, chisel bits, or the like. As illustrated in FIG. 2, the drilling tool 101 includes a body 102 having a first end 103, a second end 104 opposite the first end 103, and an axis of rotation 105. The drilling tool 101 may further include a shank 106 adjacent the first end 103 that is configured to be coupled to a power tool and at least one flute 107 that is helically wrapped about the body 102 between the first and second ends 103, 104. In the illustrated embodiment, the drilling tool 101 includes four flutes 107. In other embodiments, the drilling tool 101 may include fewer or more flutes 107. In some embodiments, the flutes 107 are helically wrapped about the body 102 at a variable helix angle R2. In other words, the angle at which the flutes 107 wrap about the body 102 changes as the flutes 107 extend between the first end 103 and the second end 104.

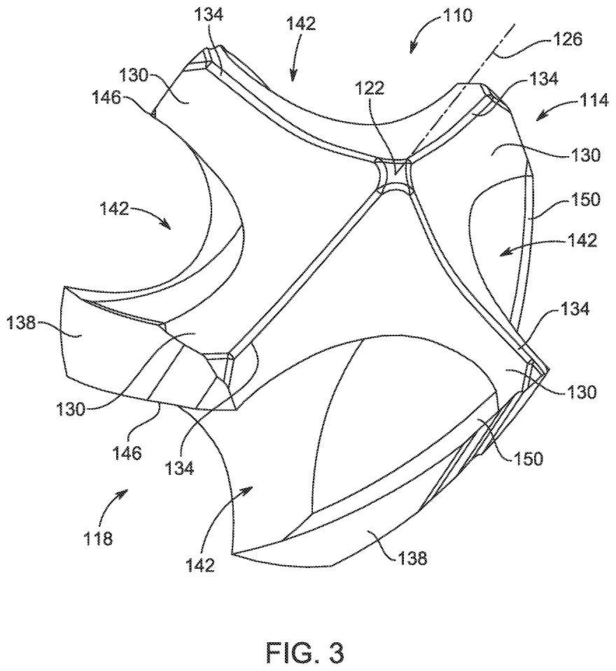

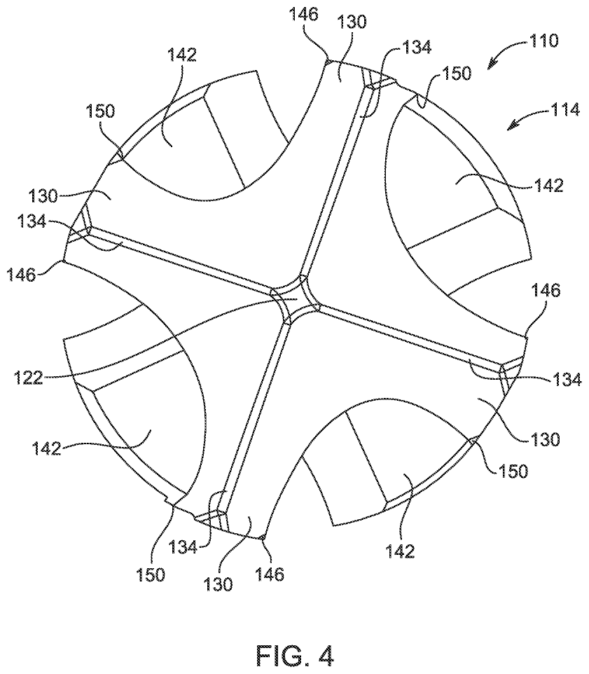

The cutting head 110 includes a first end 114 and a second end 118 opposite the first end 114. As viewed in FIG. 3, the first end 114 may also be referred to as a top end, and the second end 118 may also be referred to as a bottom end. The cutting head 110 includes a tip 122 adjacent the top end 114 that defines an axis of rotation 126 and a plurality of legs 130 extending radially from the tip 122 to an outer periphery of the cutting head 110. In the illustrated embodiment, the cutting head 110 includes four legs 130 extending from the tip 122. In other embodiments, the cutting head 110 may include more than four legs 130 or less than four legs 130 extending from the tip 122. Each leg 130 defines a cutting edge 134 that extends from the axis of rotation 126 to the outer periphery of the cutting head 110. When viewed from above (as shown in FIG. 4), the illustrated cutting edges 134 extend linearly from the tip 122 (or axis or rotation 126) to an outer periphery of the cutting head 110. However, it should be understood that the cutting edges 134 follow the contouring or topography of the top end 114 of the cutting head 110. Each of the legs 130 is generally the same shape and size. In addition, the legs 130 are evenly spaced about the axis of rotation 126. In other embodiments, the legs 130 may have different shapes and/or sizes. In addition, the legs 130 may be unevenly spaced about the axis of rotation 126. In some embodiments, some of the cutting edges 134 may be a main cutting edge and some of the cutting edges 134 may be an auxiliary cutting head.

The legs 130 are defined by lands 138 that extend axially along the axis of rotation 126 between the top and bottom ends 114, 118. In the illustrated embodiment, the lands 138 extend between the top and bottom ends 114, 118 at a helix angle R3. The helix angle R3 at which the lands 138 extend is the same as the helix angle R2 at which the flutes 107 of the body 102 extend. In some embodiments the helix angle R3 at which the lands 138 extend may be different than the helix angle R2 at which the flutes 107 of the body 102 extend. In the illustrated embodiment, the helix angle R3 is a constant angle from the top end 114 to the bottom end 118. In some embodiments, the lands 138 may extend at a variable helix angle R3 between the top and bottom ends 114, 118. In other words, the angle at which the lands 138 extend between the top end 114 and the bottom end 118 changes. Flutes 142 are defined between adjacent lands 138. In the illustrated embodiment, the number of flutes 142 correspond to the number of lands 138. As such, the illustrated cutting head 110 includes four flutes 142. In other embodiments, the cutting head 110 may include more flutes 142 or less flutes 142 depending on the number of lands 138. The flutes 142 also extend between the top and bottom ends 114, 118 of the cutting head 110 at a helix angle R3. The helix angle R3 of the flutes 142 corresponds to the helix angle R3 of the lands 138. The flutes 142 define a leading cutting edge 146 and a trailing cutting edge 150. The cutting edges 146, 150 assist in grabbing onto a material during a cutting operation. Further, the flutes 142 assist in chip removal during a drilling operation.

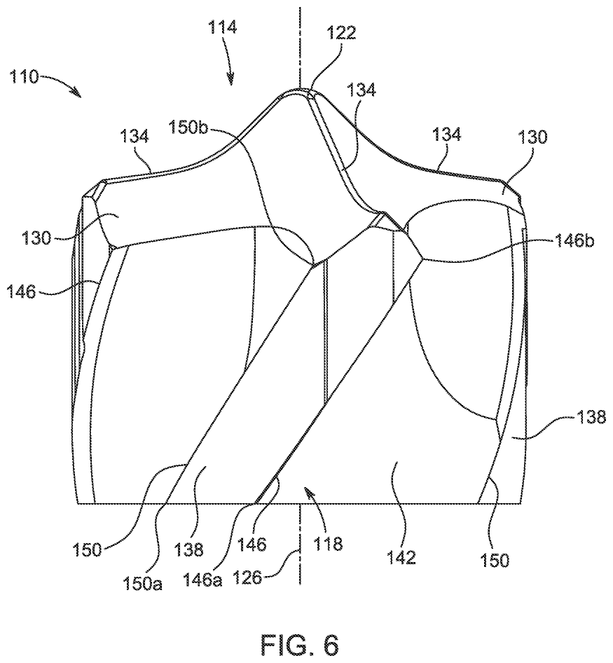

As illustrated in FIG. 6, the lands 138 extend at the helix angle R3 from the bottom end 118 to the top end 114 of the cutting head 110. As such, the leading cutting edge 146 and the trailing cutting edge 150 extend at the helix angle R3 from the bottom end 118 to the top end 114 of the cutting head 110. Specifically, the leading cutting edge 146 extends from a first circumferential point 146a on the outer periphery at the bottom end 118 of the cutting head 110 to a second circumferential point 150a on the outer periphery at the top end 114 of the cutting head 110. The leading cutting edge 146 is positioned on one circumferential side of the main cutting edge 134 at the bottom end 118 of the cutting head 110, and the leading cutting edge 146 is positioned on the other circumferential side of the main cutting edge 134 at the top end 114 of the cutting head 110. Additionally, the trailing cutting edge 150 extends from a first circumferential point 150a on the outer periphery at the bottom end 118 of the cutting head 110 to a second circumferential point 150b on the outer periphery at the top end 114 of the cutting head 110. The trailing cutting edge 150 is positioned on the same circumferential side of the main cutting edge 134 at both the bottom end 118 and the top end 114 of the cutting head 110. In addition, the trailing cutting edge 150 is positioned on the same circumferential side of the main cutting edge 134 as the first circumferential point 146a of the leading cutting edge 146. In the illustrated embodiment, the first circumferential point 146a of the leading cutting edge 146 is positioned circumferentially downstream of the second circumferential point 150b of the trailing cutting edge 150 in a direction of rotation of the cutting head 110.

The cutting head 110 is coupled to the body 102 of the drilling tool 101. In some embodiments, the bottom end 118 of the cutting head 110 may be butt-brazed, welded, or secured to the body 102 of the drilling tool 101 using other suitable means. The illustrated cutting head 110 is formed of solid carbide. In other embodiments, the cutting head 110 may be formed of high-speed steel or any other suitable hard material. In contrast, the body 102 of the drilling tool 101 may be formed of a lower cost material, such as tool steel.

In some embodiments, the cutting head 110 is manufactured using an additive manufacturing process, such as 3D printing. Specifically, the cutting head 110 is made by adding layer-upon-layer of metal material to create the general shape of the cutting head 110. To create the cutting head 110 using 3D printing, a 3D drawing of the cutting head 110 may be produced in a computer aided design (CAD) software program. Then, a printing machine reads data from the CAD file and lays down or adds successive layers of liquid powder metals in a layer-upon-layer fashion to fabricate the cutting head 110. Different sizes and/or shapes of cutting heads 110 (e.g., cutting heads having different numbers of legs 130, flutes 142, etc.) may be made using this process. In some embodiments, the cutting head 110 may be formed with the body or shaft of the drilling tool using an additive manufacturing process. In other words, the cutting head 110 may be formed with a body and a shank during the same additive manufacturing process. For example, the cutting head 110 may be first attached to the body prior to fully forming the cutting head 110. In other embodiments, the cutting head 110 may be formed using a grinding process.

In some embodiments, after the additive manufacturing or grinding process, the cutting edges 146, 150 of the flutes 142 may be cladded (e.g., laser cladded) to add strength to the highest wear spots of the cutting head 110.

In the illustrated embodiment, the flutes 142 and the lands 138 of the cutting head 110 are formed to align with the flutes 107 of the body 102 of the drilling tool 101. In other words, the cutting head 110 is formed so that there is a smooth transition between the flutes 142 of the cutting head 110 and the flutes 107 of the body 102. Further, the flutes 142 of the cutting head 110 are formed to be continuous with the flutes 107 of the body 102 such that there is no interruption between the flutes 142 of the cutting head 110 and the flutes 107 of the body 102. In contrast, the flutes 50 of the cutting head 38 of the prior art (FIG. 1) are axially straight, while the flutes 34 of the drilling tool 10 are helical. As such, there is a non-smooth transition between the flutes 50 of the cutting head 38 and the flutes 34 of the body 14.

In some embodiments, the helix angle R3 that the flutes 142 of the cutting head 110 extend is the same as, or equal to, the helix angle R2 that the flutes 107 of the body 102 extend. In embodiments where the flutes 142 extend at a variable helix angle R3, the flutes 142 of the cutting head 110 may extend at the same variable helix angle R2 as the flutes 107 of the body 102. For example, the angle of the flutes 142 at the second end 118 of the cutting head 110 may be similar to or equal to the angle of the flutes 107 of the body 102 at the second end 104 of the body 102. The flutes 107 of the body 102 may then carry on the same variable helix angle R3 as the flutes 142 of the cutting head 110, or may have a different variability, or may have a constant helix angle R3.

Although the invention is described with reference to discrete embodiments of the cutting head 110, variations of the cutting head 110 exist within the spirit and scope of the invention. Various features and advantages of the invention are set forth in the following claims.

What is claimed is:

1. A drill bit comprising:
a body including
a first end,
a second end,
an axis of rotation defined through the first end and the second end, and
a body flute that extends along the axis of rotation at a helix angle; and
a cutting head attached to the second end of the body, the cutting head including
a first land,
a second land, and
a cutting head flute defined between the first land and the second land, the cutting head flute extending along the axis of rotation at the helix angle such that the body flute and the cutting head flute form a continuous flute.

2. The drill bit of claim 1, wherein the cutting head further includes a cutting edge that extends linearly from a center of the cutting head to an outer periphery of the cutting head.

3. The drill bit of claim 1, wherein the body flute is one of a plurality of body flutes and the cutting head flute is one of a plurality of cutting head flutes, each of the plurality of body flutes and the plurality of cutting head flutes extends at the helix angle.

4. The drill bit of claim 1, wherein the cutting head has a bottom end, a top end, and an outer periphery, and wherein the first land has a cutting edge that extends from a first circumferential point on the outer periphery at the bottom end of the cutting head to a second circumferential point on the outer periphery at the top end of the cutting head.

5. The drill bit of claim 4, wherein the first circumferential point and the second circumferential point are circumferentially offset from each other.

6. The drill bit of claim 1, wherein the cutting head is welded to the second end of the body.

7. The drill bit of claim 1, wherein the cutting head further includes a third land and a fourth land, wherein each of the first, second, third, and fourth lands is spaced evenly around an outer periphery of the cutting head, and wherein the cutting head flute is one of a plurality of cutting head flutes such that each of the plurality of cutting head flutes is provided between a corresponding two of the first land, the second land, the third land, and the fourth land.

8. The drill bit of claim 1, wherein the helix angle at which the body flute extends along the axis of rotation is variable.

9. The drill bit of claim 8, wherein the helix angle of the body flute at the second end of the body is equal to the helix angle of the cutting head flute.

10. The drill bit of claim 1, wherein the cutting head is formed of carbide.

11. A drill bit comprising:
a body including a first end, a second end, and an axis of rotation defined therethrough; and
a cutting head attached to the second end, the cutting head including
a bottom end that is attached to the second end of the body,
a top end opposite the bottom end, and
a land having a leading cutting edge and a trailing cutting edge, each of the leading cutting edge and the trailing cutting edge extending between the top end and the bottom end of the cutting head and helically around the axis of rotation.

12. The drill bit of claim 11, wherein the land extends helically around the axis of rotation at a constant helix angle.

13. The drill bit of claim 11, wherein the cutting head has an outer periphery, and wherein the land further includes a main cutting edge that extends from a center of the cutting head to the outer periphery of the cutting head at the top end of the cutting head.

14. The drill bit of claim 13, wherein the main cutting edge extends linearly from the center of the cutting head to the outer periphery of the cutting head.

15. The drill bit of claim 13, wherein the main cutting edge extends from a center of the cutting head to a position between the leading cutting edge and the trailing cutting edge at the top end of the cutting head.

16. The drill bit of claim 13, wherein the leading cutting edge is positioned on one circumferential side of the main cutting edge at the bottom end of the cutting head, and wherein the leading cutting edge is positioned on the other circumferential side of the main cutting edge at the top end of the cutting head.

17. A method of manufacturing a drill bit comprising:
forming a body having a first end, a second end, an axis of rotation defined through the first end and the second end, and a body flute that extends along the axis of rotation at a helix angle;
forming a cutting head including a first land, a second land, and a cutting head flute defined between the first land and second land, the cutting head flute extending along the axis of rotation at the helix angle; and
attaching the cutting head to the second end of the body such that the body flute and the cutting head flute form a continuous flute.

18. The method of claim 17, wherein forming the cutting head includes forming the cutting head of a metal material through additive manufacturing.

19. The method of claim 18, wherein the metal material is a liquid powder carbide.

20. The method of claim 17, wherein attaching the cutting head to the body includes welding or brazing the cutting head to the body.
